(19) United States
(12) Patent Application Publication
(10) Pub. No.: US 2019/0022756 A1
(43) Pub. Date: Jan. 24, 2019

(54) METHOD OF MANUFACTURING A THREE-DIMENSIONAL OBJECT AND INK FOR MANUFACTURING A THREE-DIMENSIONAL OBJECT

(71) Applicant: MIMAKI ENGINEERING CO., LTD., Nagano (JP)

(72) Inventor: Masaru Ohnishi, Nagano (JP)

(73) Assignee: MIMAKI ENGINEERING CO., LTD., Nagano (JP)

(21) Appl. No.: 16/027,244

(22) Filed: Jul. 3, 2018

(30) Foreign Application Priority Data
Jul. 19, 2017 (JP) 2017-139940

(51) Int. Cl. B22F 3/24; B22F 3/105; B29C 64/165; B29C 67/00; B22F 1/00

(52) U.S. Cl. CPC B22F 3/24; B22F 3/1055; B29C 64/165; B29C 67/0007; B33Y 10/00; B22F 2003/1059; B22F 2003/247; B22F 2001/0066; B22F 1/0074

(57) ABSTRACT

Provided are a method of manufacturing a three-dimensional object and an ink for manufacturing a three-dimensional object, which are capable of suppressing the scattering of powder when a three-dimensional object is manufactured by laser sintering. The method of manufacturing a three-dimensional object includes: a building material layer forming step of forming a building material layer on a working surface, and the building material layer including a building material in powdered form, which is a raw material for a three-dimensional object, and a solvent for dispersing the building material; a sintering step of sintering the building material included in a building part of the building material layer corresponding to the three-dimensional object; and a removal step of removing an unsintered building material and the solvent from the building material layer such that a sintered building material is left on the working surface.

### CROSS REFERENCE TO RELATED APPLICATIONS

This application claims the priority benefit of Japanese Patent Application No. 2017-139940, filed on Jul. 19, 2017. The entirety of the above-mentioned patent application is hereby incorporated by reference herein and made a part of this specification.

### TECHNICAL FIELD

The present disclosure relates to a method of manufacturing a three-dimensional object and an ink for manufacturing a three-dimensional object.

### BACKGROUND ART

A method of manufacturing a three-dimensional object by what is called laser sintering, where a three-dimensional object is manufactured by forming powder of metal or plastic into layers and irradiating the powder with a laser to sinter the powder, is known (see, for example, Patent Literature 1).
Patent Literature 1: Japanese Unexamined Patent Publication No. 2017-115194

In the manufacturing method described in Patent Literature 1, the powder can scatter. When the powder scatter, the surroundings are contaminated, and the powder as raw material is wasted.

### SUMMARY

The present disclosure has been made in view of the above, and provides a method of manufacturing a three-dimensional object and an ink for manufacturing a three-dimensional object that are capable of suppressing the scattering of powder when a three-dimensional object is manufactured by a laser sintering.

A method of manufacturing a three-dimensional object according to the present disclosure includes: a building material layer forming step of forming a building material layer on a working surface, wherein the building material layer including: a building material in a powdered form, which is a raw material for a three-dimensional object and is sintered when irradiated with a laser light, and a solvent for dispersing the building material; a sintering step of irradiating a building part of the building material layer corresponding to the three-dimensional object with the laser light to sinter the building material; and a removal step of removing an unsintered building material and the solvent from the building material layer such that a sintered building material is left on the working surface.

According to the present disclosure, at the building material layer forming step, the building material in the powdered form is formed on the working surface as the building material layer including the solvent. Thus, the scattering of the building material can be suppressed. Consequently, contamination of the surroundings can be suppressed, and the waste of the building material can be reduced.

In the above-mentioned method of manufacturing a three-dimensional object, the building material layer forming step includes: ejecting an ink containing the building material and the solvent onto the working surface by an inkjet printing to form an ink layer, and removing a part of the solvent from the ink layer formed on the working surface.

According to the present disclosure, a part of the solvent is removed from the ink layer after the ink layer is formed by the inkjet printing, and hence the building material layer containing the solvent can be easily formed.

In the above-mentioned method of manufacturing a three-dimensional object, the building material layer forming step includes: disposing an ink containing the building material and the solvent onto the working surface in a layered manner by a screen printing.

According to the present disclosure, the ink containing the building material and the solvent is disposed on the working surface in a layered manner by the screen printing, and hence the building material layers containing the solvent can be easily formed.

The above-mentioned method of manufacturing a three-dimensional object further includes: a depositing step of depositing a new building material layer on the building material layer which is formed on the working surface and in which the building material has been sintered, and the sintering step includes: irradiating a building part of the new building material layer corresponding to a shape of the three-dimensional object with the laser light to sinter the building material.

According to the present disclosure, the new building material layer is deposited on the building material layer in which the building material has been sintered, and the new building material layer is irradiated with the laser light to sinter the building material, and hence the three-dimensional object can be efficiently manufactured while the scattering of the building material is suppressed.

In the above-mentioned method of manufacturing a three-dimensional object, the removal step includes: removing the unsintered building materials and the solvents from a plurality of the building material layers which are deposited.

According to the present disclosure, unsintered parts can be collectively removed from a plurality of deposited building material layers at the removal step, and hence the removal step can be efficiently performed. Beside, in the above-mentioned method of manufacturing a three-dimensional object, the building material layer forming step includes: ejecting an ink containing a coloring material, the building material and the solvent onto the working surface by an inkjet printing to form an ink layer; and removing a part of the solvent from the ink layer formed on the working surface.

An ink for manufacturing a three-dimensional object according to the present disclosure includes: a building material in a powdered form, which is a raw material for a three-dimensional object and is sintered when irradiated with a laser light; a solvent for dispersing the building material; and a binder for coupling particles of the building material in the solvent. Besides, in the ink for manufacturing a three-dimensional object according to the present disclosure, the ink further include a coloring material, being dispersed in the solvent.

According to the present disclosure, particles of the building material are coupled by the binder in the solvent, and hence the scattering of the building material can be suppressed. Consequently, contamination of the surroundings can be suppressed, and the waste of the building material can be reduced.

The present disclosure can provide a method of manufacturing a three-dimensional object and an ink for manufacturing a three-dimensional object that are capable of suppressing the scattering of powder when a three-dimensional object is manufactured by a laser sintering.

### BRIEF DESCRIPTION OF THE DRAWINGS

FIG. 1 is a flowchart illustrating an example of a manufacturing method of a three-dimensional object according to a first embodiment.

FIG. 2A and FIG. 2B are diagrams illustrating a manufacturing process for a three-dimensional object according to the first embodiment.

FIG. 3A and FIG. 3B are diagrams illustrating a manufacturing process for a three-dimensional object according to the first embodiment.

FIG. 4A and FIG. 4B are diagrams illustrating a manufacturing process for a three-dimensional object according to the first embodiment.

FIG. 5A and FIG. 5B are diagrams illustrating a manufacturing process for a three-dimensional object according to a second embodiment.

FIG. 6A and FIG. 6B are diagrams illustrating a manufacturing process for a three-dimensional object according to the second embodiment.

FIG. 7A and FIG. 7B are diagrams illustrating a manufacturing process for a three-dimensional object according to the second embodiment.

FIG. 8A and FIG. 8B are diagrams illustrating a manufacturing process for a three-dimensional object according to a third embodiment.

FIG. 9A and FIG. 9B are diagrams illustrating a manufacturing process for a three-dimensional object according to the third embodiment.

FIG. 10A and FIG. 10B are diagrams illustrating a manufacturing process for a three-dimensional object according to the third embodiment.

### DESCRIPTION OF EMBODIMENTS

A method of manufacturing a three-dimensional object and an ink for manufacturing a three-dimensional object according to embodiments of the present disclosure are described below with reference to the accompanying drawings. The present disclosure is not limited by the embodiments. Components in the following embodiments include the ones that can be easily replaced by a person skilled in the art and the ones that are substantially the same.

### First Embodiment

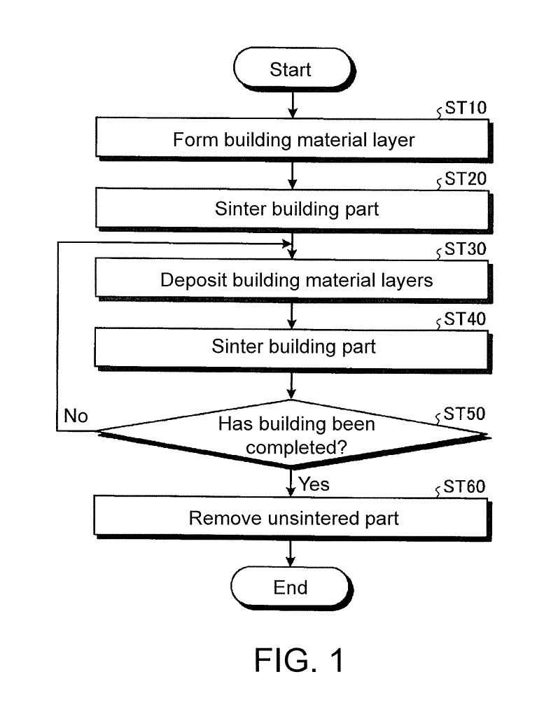

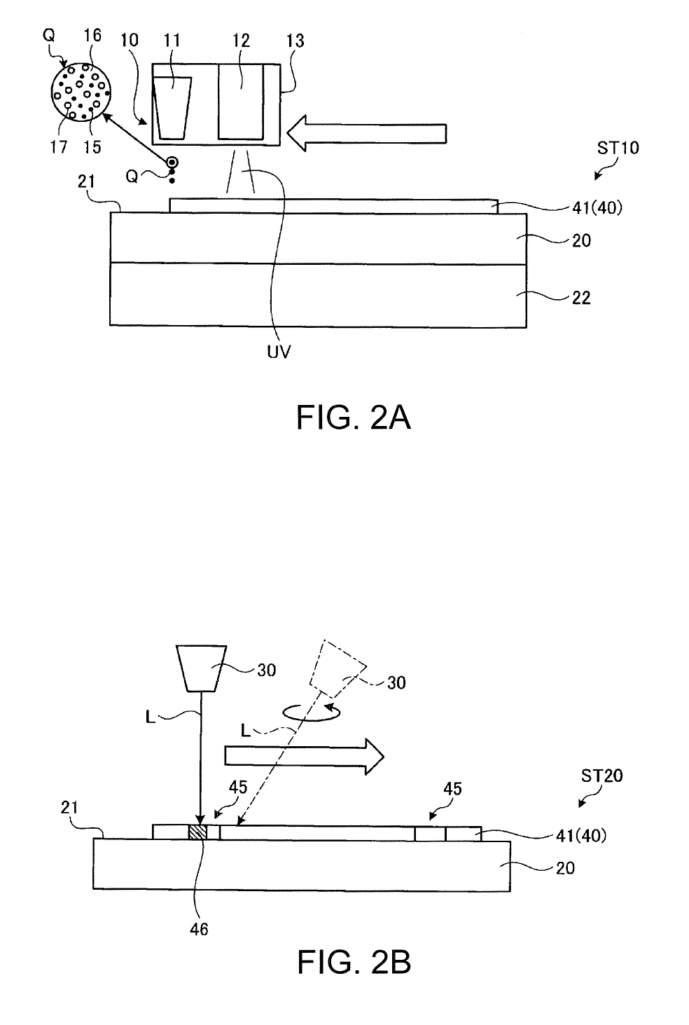

FIG. 1 is a flowchart illustrating an example of a method of manufacturing a three-dimensional object according to a first embodiment. FIGS. 2A to 4B are diagrams illustrating processes of manufacturing a three-dimensional object according to the first embodiment. As illustrated in FIG. 1 and FIG. 2A, in the method of manufacturing a three-dimensional object according to the first embodiment, a building material layer forming step ST10 is first performed.

At the building material layer forming step ST10, an inkjet printer 10 is used to form a three-dimensional object on a working surface 21 of a mount 20. For example, the mount 20 is heated by a printer heater 22.

The inkjet printer 10 includes an inkjet head 11, a drying device 12, and a carriage 13 in which the inkjet head 11 and the drying device 12 are mounted. The inkjet printer 10 ejects an ink Q to the working surface 21 from nozzles of the inkjet head 11 while scanning the working surface 21 in one direction with the carriage 13. As the inkjet head 11, a piezoelectric head or a thermal jet head may be used. The inkjet head 11 may be a multi-pass head or a linear single pass head. The inkjet head 11 may be a low-resolution head or a dispenser.

The ink Q contains a building material 15 as a raw material for a three-dimensional object 100 and a solvent 16 for dispersing the building material 15. Examples of the building material 15 include metal that dissolves by heat, ceramic, and plastic powder of a thermoplastic resin or a thermosetting resin. Examples of the solvent 16 include water, ethylene glycol-based solvent or alcohol-based solvent. As the solvent 16, for example, solvents such as ethylene glycol monobutyl ether acetate, ethylene glycol monopropyl ether, diethylene glycol monobutyl ether, diethylene glycol ethyl methyl ether, diethylene glycol diethyl ether, propylene glycol monomethyl ether, propylene glycol monomethyl ether acetate, dipropylene glycol monomethyl ether, dipropylene glycol dimethyl ether, butyl acetate, and 3-methoxybutyl acetate may be used. The ink Q may be added with a thickening agent or a sizing agent such as glycerin, ethylene glycol, or water-soluble polyvinyl alcohol. The ink Q may contain a binder 17 for coupling particles of the building material 15 in the solvent 16. Examples of the binder 17 include organic binders such as starch or polyvinyl alcohol.

The drying device 12 is disposed side by side with the inkjet head 11 in a main scanning direction of the carriage 13. The drying device 12 includes a light source (not shown) configured to emit ultraviolet rays UV. The drying device 12 irradiates the ink Q ejected onto the working surface 21 with ultraviolet rays UV to evaporate the solvent 16 contained in the ink Q.

At the building material layer forming step ST10, first, the inkjet printer 10 disposes the ink Q on the entire surface of the region of the working surface 21 in a layered manner to form an ink layer 44. After that, the drying device 12 irradiates the ink layer 44 with ultraviolet rays UV such that a part of the solvent 16 contained in the ink layer 44 is evaporated due to energy of the ultraviolet rays UV. When a part of the solvent 16 is evaporated, the volume ratio of the solvent 16 in the ink layer 44 is decreased to increase the viscosity, and a building material layer 40 is formed. The building material layer 40 having the increased viscosity is semi-solidified or solidified and is prevented from spreading on the working surface 21, and hence the shape of the building material layer 40 is maintained. A part of the solvent 16 can be evaporated by heating from the printer heater 22.

For example, the ratio of the solvent 16 in the ink Q is set to about 20 vol % by using the drying device 12 and the printer heater 22. Specifically, even after the solvent 16 is evaporated from the building material layer 40 by the drying device 12 and the printer heater 22, the solvent 16 is contained in the building material layer 40. Thus, the scattering of the building material 15 contained in the building material layer 40 is suppressed.

Next, as illustrated in FIG. 2B, a sintering step ST20 is performed by using a laser head 30. As the laser head 30, for example, a semiconductor laser, a pulse laser, an excimer laser, or a laser of various kinds of gases (such as carbon dioxide laser) can be used. The laser head 30 irradiates a building part of the building material layer 40 where a three-dimensional object is to be built with a laser light L. When irradiated with the laser light L, the building material 15 included in the building part is sintered by thermal energy of the laser light L, and a sintered portion 46 is formed. At the sintering step ST20, the irradiation direction of the laser light L can be adjusted. For example, the irradiation direction of the laser light L at the sintering step ST20 in the first embodiment has been described by way of example where the building material layer 40 is irradiated with the laser light L perpendicularly from above the building material layer 40, but the irradiation direction is not limited thereto. For example, the laser light L may be applied in a direction inclined with respect to the perpendicular direction. By rotating the laser head 30 in the state in which the laser light L is applied in the direction inclined with respect to the perpendicular direction, the laser light L can be easily applied to an annular region.

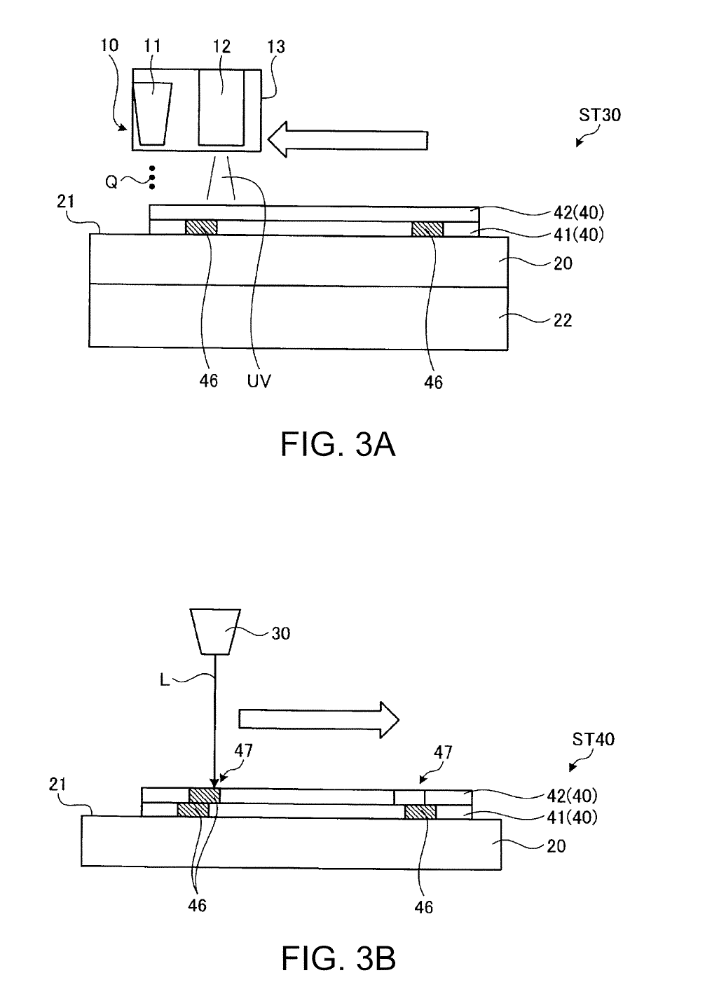

Next, as illustrated in FIG. 3A, at a depositing step ST30, the inkjet printer 10 is used similarly to the building material layer forming step ST10. At the depositing step ST30, a new building material layer 40 is formed on the building material layer 40 that has been processed with the sintering step ST20. In the following, when it is necessary to distinguish the building material layers 40 formed on the working surface 21 from each other, the lower building material layer 40 is referred to as “building material layer 41”, and the upper building material layer 40 is referred to as “building material layer 42”. At the depositing step ST30, for example, the building material layer 42 is formed over substantially the entire surface of the lower building material layer 41 by the same method as for the building material layer forming step ST10.

Next, as illustrated in FIG. 3B, a sintering step ST40 is performed by using the laser head 30 similarly to the sintering step ST20. The laser head 30 irradiates a building part of the building material layer 42 where a three-dimensional object is to be built with the laser light L. When irradiated with the laser light L, the building material 15 included in the building part is sintered by energy of the laser light L. At the sintering step ST40, when irradiated with the laser light L, the building part disposed to overlap with the sintered portion 46 of the lower building material layer 41 is sintered integrally with the sintered portion 46 of the lower building material layer 41.

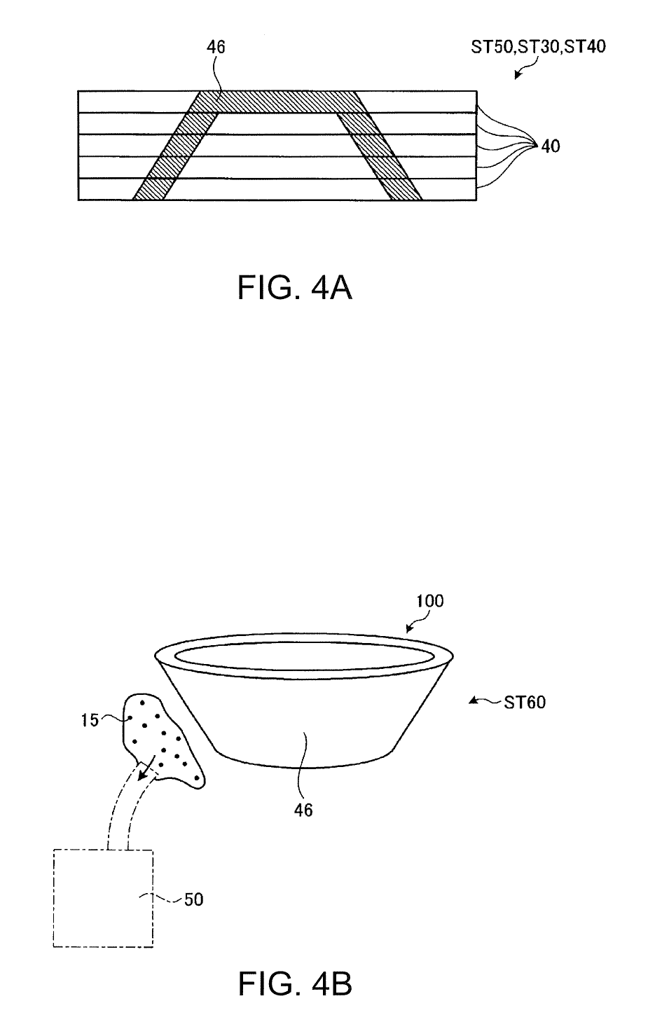

Next, as illustrated in FIG. 4A, when a three-dimensional object is not completed when the sintering step ST40 has ended (No, at Step ST50), the depositing step ST30 and the sintering step ST40 are repeatedly performed until the three-dimensional object is completed. When the three-dimensional object is completed by the sintered portion 46 as illustrated in FIG. 4A as a result of the depositing step ST30 and the sintering step ST40 (Yes, at Step ST50), a removal step ST60 is performed.

At the removal step ST60, as illustrated in FIG. 4B, an unsintered part that has not been sintered and the solvent 16 are collectively removed from the deposited building material layers 40. At the removal step ST60, for example, the deposited building material layers 40 are immersed in a liquid such as water to remove the unsintered part. When the binder 17 is contained in the ink Q, a solvent for dissolving the binder 17 may be added to the liquid. In this manner, the binder 17 can be dissolved, and hence the coupling of the building materials 15 is released to enable powder to be easily removed. At the removal step ST60, the unsintered part is removed, and hence the sintered portion 46 is left on the working surface 21. By collectively removing the unsintered part in this manner, the sintered portion 46 can be efficiently left on the working surface 21. The sintered portion 46 left on the working surface 21 is obtained as a three-dimensional object 100. The unsintered part removed at the removal step ST60 is collected by using a collection device 50 or the like and can be reused. Thus, the waste of the building material 15 can be reduced.

The method of manufacturing a three-dimensional object according to the first embodiment includes: the building material layer forming step ST10 of forming a building material layer 40 on a working surface 21, and the building material layer 40 including a building material 15 as a raw material for a three-dimensional object 100 and a solvent 16 for dispersing the building material 15; the sintering step ST20 of irradiating a building part 45 of the building material layer 40 corresponding to the three-dimensional object 100 with a laser light L to sinter the building material 15; and the removal step ST60 of removing an unsintered building material 15 and the solvent 16 from the building material layer 40 such that a sintered portion 46 that is a sintered building material 15 is left on the working surface 21.

With this configuration, at the building material layer forming step ST10, the building material 15 in a powdered form is formed on the working surface 21 as the building material layer 40 containing the solvent 16. Thus, the scattering of the building material 15 can be suppressed. Consequently, contamination of the surroundings can be suppressed, and the waste of the building material 15 can be reduced. As the building material 15, not only a resin material such as UV curable ink but also metal or ceramic can be used, and hence a three-dimensional object 100 with high heat resistance or high weather resistance can be manufactured. Because the irradiation angle of the laser light L can be adjusted, the three-dimensional object 100 can be manufactured with high accuracy.

In the above-mentioned method of manufacturing a three-dimensional object, the building material layer forming step ST10 includes: ejecting an ink Q containing the building material 15 and the solvent 16 onto the working surface 21 to form an ink layer 44, and removing a part of the solvent 16 from the ink layer 44 formed on the working surface 21. Consequently, the building material layer 40 can be easily formed by using an inkjet device.

The above-mentioned method of manufacturing a three-dimensional object further includes: a depositing step ST30 of depositing a new building material layer 42 on the building material layer 41 which is formed on the working surface 21 and in which the building material 15 has been sintered, and the sintering step includes a sintering step ST40 of irradiating a building part 47 of the new building material layer 42 corresponding to the three-dimensional object 100 with the laser light L to sinter the building material 15. In this manner, the new building material layer 42 is deposited on the building material layer 41 in which the building material 15 has been sintered, and the new building material layer 42 is irradiated with the laser light L to sinter the building material 15, and hence the three-dimensional object 100 can be efficiently manufactured while the scattering of the building material 15 is suppressed.

In the above-mentioned method of manufacturing a three-dimensional object, the removal step ST60 includes: collectively removing an unsintered building material 15 and the solvent 16 from the building material layers 40 which are deposited. Consequently, the removal step ST60 can be efficiently performed, and hence the time required for the overall process can be reduced.

The ink Q according to the first embodiment includes a building material 15 in a powdered form, which is a raw material for a three-dimensional object 100 and is sintered when irradiated with the laser light L, a solvent 16 for dispersing the building material 15, and a binder 17 for coupling particles of the building material 15 in the solvent 16. Particles of the building material 15 are coupled by the binder 17 in the solvent 16, and hence the scattering of the building material 15 can be suppressed. Consequently, contamination of the surroundings can be suppressed, and the waste of the building material 15 can be reduced.

### Second Embodiment

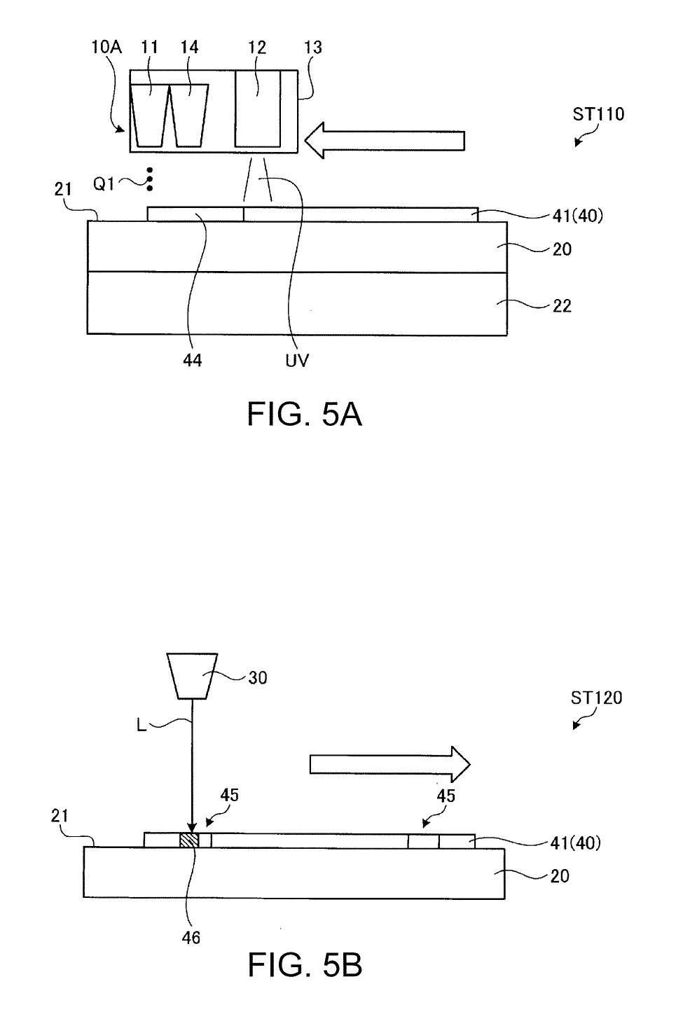

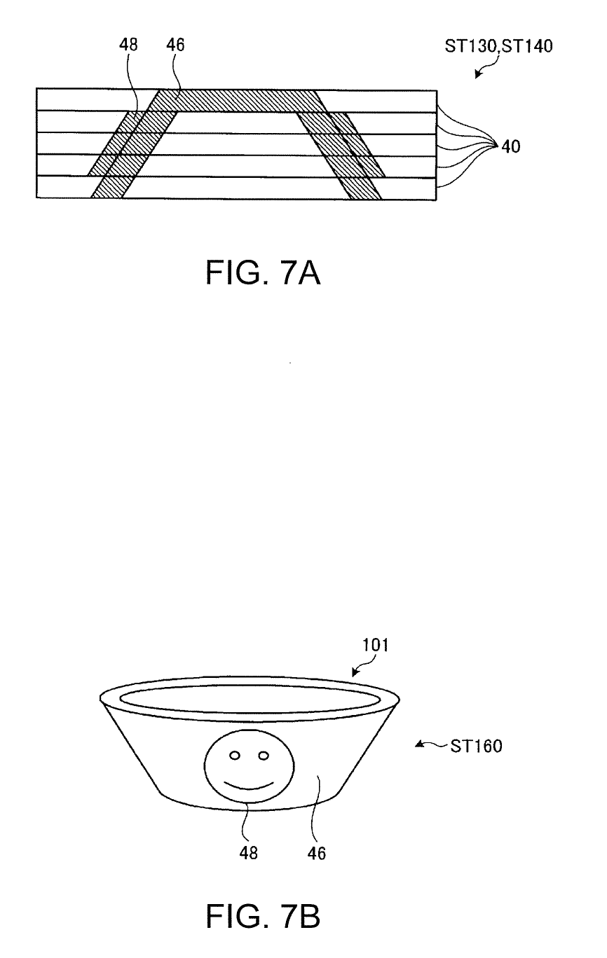

Next, a second embodiment is described. In the second embodiment, the case where a three-dimensional object 101 (see FIG. 7B) provided with patterns, design, and the like is manufactured is described as an example. FIGS. 5A to 7B are diagrams illustrating processes for manufacturing a three-dimensional object according to the second embodiment. Similarly to the first embodiment, a method of manufacturing a three-dimensional object according to the second embodiment includes a building material layer forming step ST110, a sintering step ST120, a depositing step ST130 of depositing building material layers, a sintering step ST140, and a removal step 160 performed when a three-dimensional object has been completed when the sintering step ST140 has ended (Yes, at Step ST150).

As illustrated in FIG. 5A, in the second embodiment, an inkjet printer 10A includes inkjet heads 11 and 14 configured to eject different kinds of ink. The inkjet head 11 ejects an ink Q1 having the same components as those in the ink Q in the first embodiment.

The inkjet head 14 ejects a coloring ink Q2. For example, the coloring ink Q2 contains particles of inorganic pigment or organic pigment as a coloring material. The coloring ink Q2 contains, as a solvent 16, for example, water, a solvent 16 in which an ethylene glycol-based solvent, an alcohol-based solvent or a hydrocarbon-based solvent is used along or a solvent 16 in which these solvents are mixed. When sintered at the sintering step ST120 described later, the coloring ink Q2 develops color different from the ink Q1 to form patterns, design, and the like of the three-dimensional object.

At the building material layer forming step ST110 in the second embodiment, for example, similarly to the first embodiment, the inkjet printer 10A controls the inkjet head 11 to dispose the ink Q on the entire surface of the region of a working surface 21 in a layered manner to form an ink layer 44. If necessary, the inkjet printer 10A may eject the coloring ink Q2 from the inkjet head 14 to dispose a layer of the coloring ink Q2 on a part of the ink layer 44.

After that, similarly to the first embodiment, the drying device 12 irradiates the ink layer 44 with ultraviolet rays UV such that a part of the solvent 16 contained in the ink layer 44 is evaporated due to energy of the ultraviolet rays UV. Even after the building material layer 40 is irradiated with the ultraviolet rays UV from the drying device 12, the solvent 16 is contained in the building material layer 40. Thus, the scattering of the building material 15 contained in the building material layer 40 is suppressed.

Next, as illustrated in FIG. 5B, the sintering step ST120 is performed by using the laser head 30. The laser head 30 irradiates a building part 45 of the building material layer 41 where a three-dimensional object is to be built with the laser light L. When irradiated with the laser light L, the building material 15 included in the building part 45 is sintered by thermal energy of the laser light L, and a sintered portion 46 is formed.

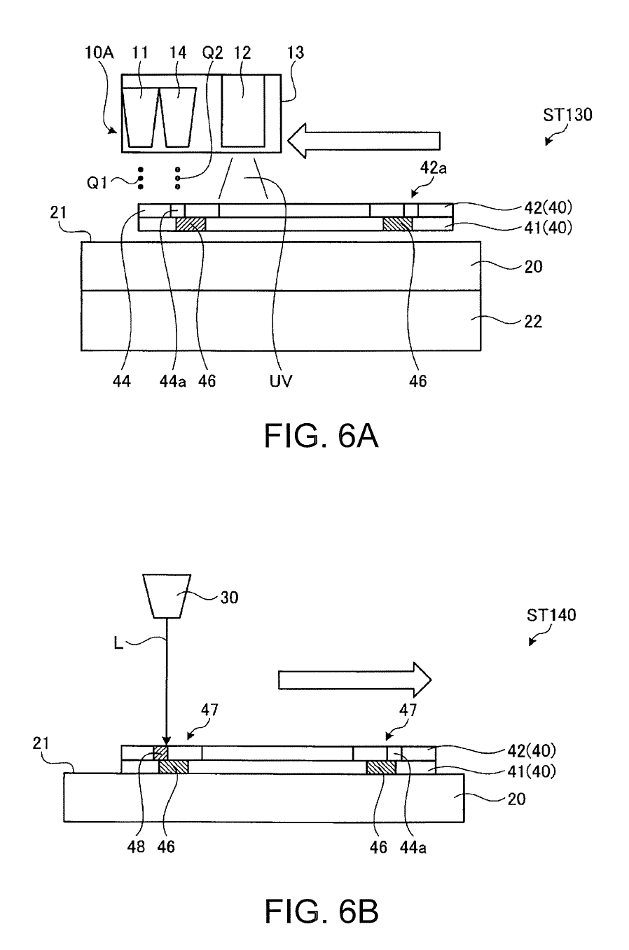

Next, as illustrated in FIG. 6A, the depositing step ST130 is performed by using the inkjet printer 10A. At the depositing step ST130, a new building material layer 42 is formed on the building material layer 41 that has been processed with the sintering step ST20. For example, the new building material layer 42 is formed over substantially the entire surface of the lower building material layer 41 by the same method as for the building material layer forming step ST110.

At the depositing step ST130 in the second embodiment, as illustrated in FIG. 6A, the inkjet head 11 ejects the ink Q1 to form an ink layer 44. The inkjet head 14 ejects the coloring ink Q2 to form a coloring ink layer 44a made of the coloring ink Q2 on a part of the ink layer 44. The drying device 12 irradiates the ink layer 44 and the coloring ink layer 44a formed on the working surface 21 with ultraviolet rays UV to evaporate part of the solvent 16 contained in the ink layer 44 and the coloring ink layer 44a. In this manner, a building material layer 42 including a coloring material layer 42a is formed.

Next, as illustrated in FIG. 6B, the sintering step ST140 is performed by using the laser head 30 similarly to the sintering step ST120. The laser head 30 irradiates a building part 47 of the building material layer 42 where a three-dimensional object is to be built with the laser light L. When irradiated with the laser light L, the building material 15 included in the building part 47 is sintered due to energy of the laser light L. At the sintering step ST140, when irradiated with the laser light L, the building material 15 included in the building part 47 that is disposed to overlap with the sintered portion 46 of the lower building material layer 41 is sintered integrally with the sintered portion 46 of the lower building material layer 41. When irradiated with the laser light L, the coloring material layer 42a is sintered to be a colored portion 48.

When a three-dimensional object is not completed when the sintering step ST140 has ended (No, at Step ST150), the depositing step ST130 and the sintering step ST140 are repeatedly performed until the three-dimensional object is completed. When the three-dimensional object is completed by the sintered portion 46 as illustrated in FIG. 7A as a result of the depositing step ST130 and the sintering step ST140 (Yes, at Step ST150), the removal step ST160 is performed.

The removal step ST160 can be performed in the same procedure as in the first embodiment. By performing the removal step ST160, as illustrated in FIG. 7B, the unsintered part is removed, and the sintered portion 46 is left on the working surface 21. By collectively removing the unsintered part in this manner, the sintered portion 46 can be efficiently left on the working surface 21. The sintered portion 46 left on the working surface 21 is obtained as a three-dimensional object 101.

In the method of manufacturing a three-dimensional object according to the second embodiment, at least one of the building material layer forming step ST110 and the depositing step ST130 includes ejecting the coloring ink Q2 to form the coloring ink layer 44a, and evaporating part of the solvent 16 contained in the coloring ink layer 44a. Consequently, the three-dimensional object 101 provided with patterns, design, and the like can be obtained.

### Third Embodiment

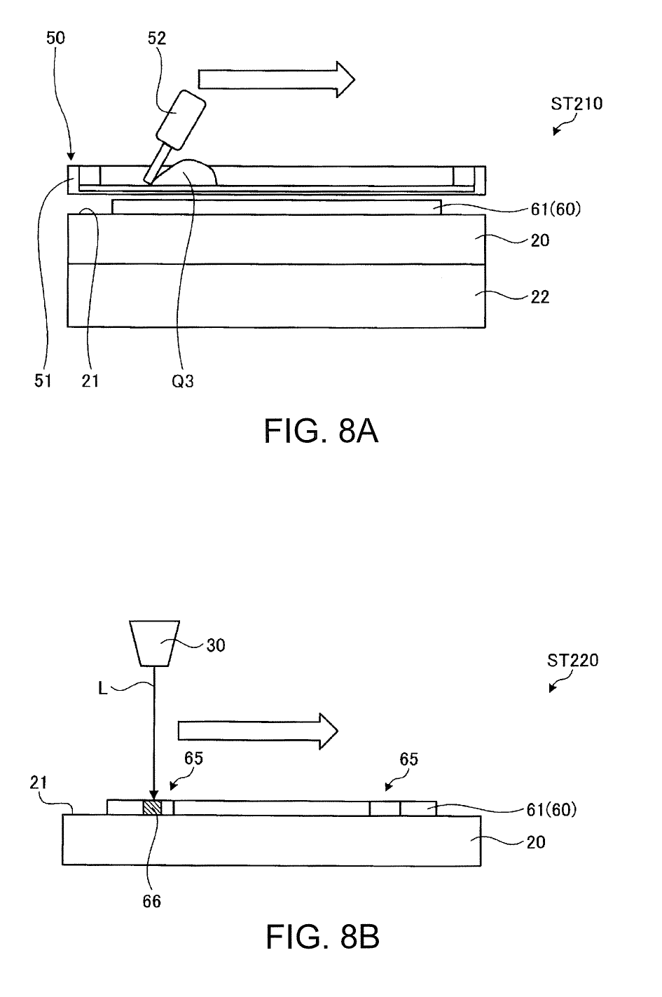

Next, a third embodiment is described. FIGS. 8A to 10B are diagrams illustrating processes for manufacturing a three-dimensional object according to the third embodiment. Similarly to the first embodiment, a method of manufacturing a three-dimensional object according to the third embodiment includes a building material layer forming step ST210, a sintering step ST220, a depositing step ST230 of depositing building material layers, a sintering step ST240, and a removal step 260 performed when a three-dimensional object is completed when the sintering step ST240 has ended (Yes, at Step ST250). In the third embodiment, the case where a building material layer is formed by a screen printing at the building material layer forming step ST210 and the depositing step ST230 is described as an example.

As illustrated in FIG. 8A, in the third embodiment, at the building material layer forming step ST210, a screen printing device 50 disposes an ink Q3 disposed on a screen 51 onto a working surface 21 by using a squeegee 52. The ink Q3 contains a building material 15 as a raw material for a three-dimensional object and a solvent 16 for dispersing the building material 15. The ink Q3 may contain a binder 17. Components of the building material 15 and the solvent 16 are the same as those in the ink Q1 in the above-mentioned embodiments. In the ink Q3, the volume ratio of the solvent 16 is lower than that of the ink Q1 in the above-mentioned embodiments. Thus, the viscosity of the ink Q3 is higher than the viscosity of the ink Q1 in the above-mentioned embodiments. Accordingly, at the building material layer forming step ST210, the building material layer 60 is not necessarily required to be irradiated with ultraviolet rays to evaporate part of the solvent 16.

Next, as illustrated in FIG. 8B, at the sintering step ST220, the laser head 30 irradiates a building part 65 of the building material layer 60 where a three-dimensional object is to be built with the laser light L. When irradiated with the laser light L, the building material 15 included in the building part 65 is sintered due to thermal energy of the laser light L to form a sintered portion 66.

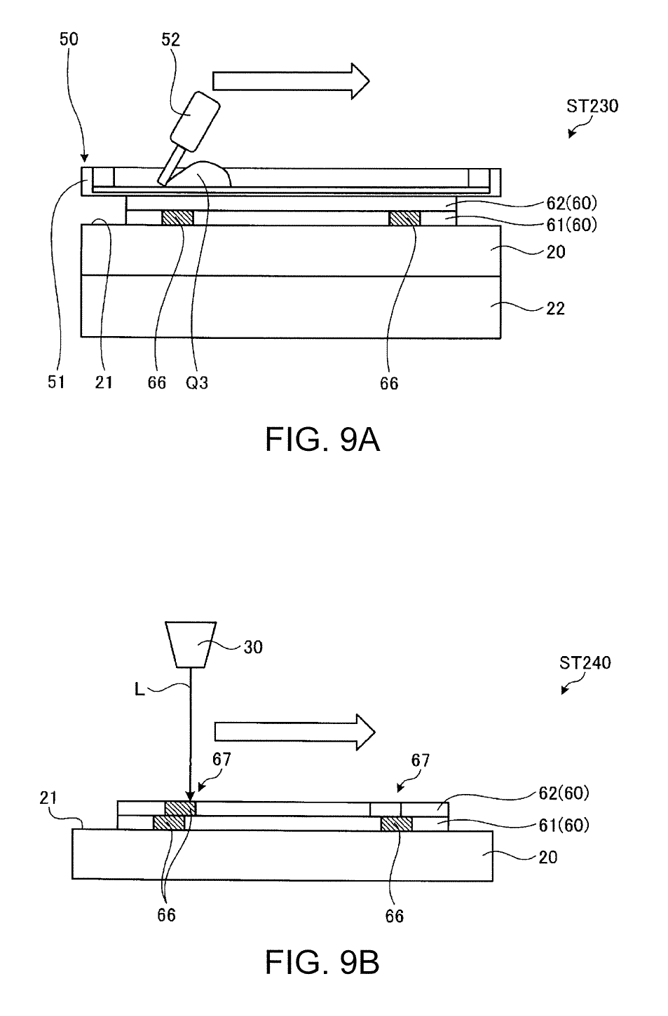

Next, as illustrated in FIG. 9A, at the depositing step ST230, a screen printing device 50 is used similarly to the building material layer forming step ST210. At the depositing step ST230, a new building material layer 60 is formed on a building material layer 60 that has been processed with the sintering step ST220. In the following, when it is necessary to distinguish the building material layers 60 formed on the working surface 21 from each other, the lower building material layer 60 is referred to as “building material layer 61”, and the upper building material layer 60 is referred to as “building material layer 62”. At the depositing step ST230, for example, the building material layer 62 is formed over substantially the entire surface of the lower building material layer 61 by the same method as for the building material layer forming step ST210.

Next, as illustrated in FIG. 9B, the sintering step ST240 is performed by using the laser head 30 similarly to the sintering step ST220. The laser head 30 irradiates a building part 67 of the building material layer 62 where a three-dimensional object is to be built with the laser light L. When irradiated with the laser light L, the building material 15 included in the building part 67 is sintered due to energy of the laser light L. At the sintering step ST240, when irradiated with the laser light L, the building part 67 disposed to overlap with the sintered portion 66 of the lower building material layer 61 is sintered integrally with the sintered portion 66 of the lower building material layer 61.

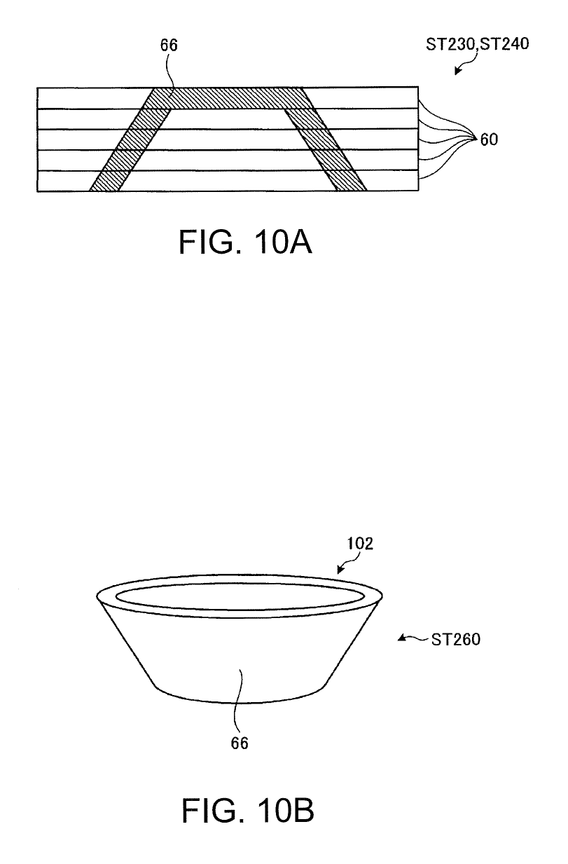

After that, similarly to the first embodiment, when a three-dimensional object is not completed when the sintering step ST240 has ended, the depositing step ST230 and the sintering step ST240 are repeatedly performed until the three-dimensional object is completed. When the three-dimensional object is completed by the sintered portion 66 as illustrated in FIG. 10A as a result of the depositing step ST230 and the sintering step ST240, the removal step ST260 is performed.

The removal step ST260 can be performed in the same procedure as in the first embodiment. By performing the removal step ST260, as illustrated in FIG. 10B, the unsintered part is removed, and the sintered portion 66 is left on the working surface 21. By collectively removing the unsintered part, the sintered portion 66 can be efficiently left on the working surface 21. The sintered portion 66 left on the working surface 21 is obtained as a three-dimensional object 102.

In the method of manufacturing a three-dimensional object according to the third embodiment, at least one of the building material layer forming step ST210 and the depositing step ST130 includes disposing the ink Q3 containing the building material 15 and the solvent 16 on the working surface 21 in a layered manner by a screen printing. Consequently, the building material layer 60 made of the ink Q3 having high viscosity can be easily disposed on the working surface 21.

The technical scope of the present disclosure is not limited to the above-mentioned embodiments and can be changed as appropriate within the range not departing from the gist of the present disclosure. For example, the building material 15 contained in the inks Q, Q1, and Q3 is not limited to the above. For example, the following inorganic material or organic material may be used. As the inorganic material, for example, ceramic, inorganic pigment, metal, an alloy, metal oxide, clay, or a mixture thereof may be used. A viscous substance added with an organic binder may also be used. In this case, the organic binder is vaporized or burned and most of the organic binder disappears at the time of sintering described later, and hence the shape can be maintained at the time of processing.

For example, a thermosetting resin such as a polyurethane resin, a silicone resin, a phenol resin, an epoxy resin, a melamine resin, an iodine resin, an unsaturated polyester resin, and a diacryl phthalate resin may be used in the form of colloid or emulsion.

As the thermoplastic resin, acryl, polyacetal, polyamide, polyethylene, polyethylene terephthalate, polycarbonate, polystyrene, polyphenylene sulfide, polybutylene terephthalate, polyvinyl chloride, an ABS resin, acrylonitrile, or a styrene resin can be used.

Example of the coloring material contained in the coloring ink Q2 include inorganic pigments such as a ceramic pigment and metal powder and flux powder such as glaze and lead glass. As the coloring material, not only coloring materials of various kinds of natural colors of yellow, magenta, cyan, and black but also coloring materials of white, pearl, metallic, fluorescence, phosphorescence, and luminous color may be used.

In the above-mentioned embodiments, the case where a solvent is used as the solvent 16 for adjusting the viscosities of the inks Q, Q1, and Q3 and the coloring ink Q2 has been described as an example, but the embodiments are not limited thereto. For example, for a binder 17 such as starch or polyvinyl alcohol or a sintering ink used when a hydrophilic viscosity modifier is used, the viscosity may be adjusted by adjusting the water content.

The ink Q in the above-mentioned first embodiment and the ink Q1 and the coloring ink Q2 in the above-mentioned second embodiment may contain an ultraviolet absorber in order to efficiently absorb ultraviolet (UV) rays applied from the drying device 12. In this case, as the ultraviolet absorber, for example, an inorganic substance such as zinc oxide, isopropylthioxanthone, a benzotriazole-based ultraviolet absorber, a triazine-based ultraviolet absorber, or a benzophenone-based ultraviolet absorber can be used. In this case, each ultraviolet absorber can be added to the inks Q and Q1 and the coloring ink Q2 by about 0.05 to several % by weight.

In the above-mentioned embodiments, the case where a three-dimensional object is obtained by performing the removal step has been described as an example, but the embodiments are not limited thereto. For example, after the removal step is performed, the obtained three-dimensional object may be polished to improve surface accuracy. The obtained three-dimensional object may be coated with glaze and baked. In the case where a three-dimensional object is manufactured by using resin as the building material 15, the surface of the obtained three-dimensional object may be coated with a resin layer and finished.

What is claimed is:

1. A method of manufacturing a three-dimensional object, comprising:
a building material layer forming step of forming a building material layer on a working surface, wherein the building material layer including: a building material in a powdered form which is a raw material for a three-dimensional object and is sintered when irradiated with a laser light, and a solvent for dispersing the building material;
a sintering step of irradiating a building part of the building material layer corresponding to the three-dimensional object with the laser light to sinter the building material; and
a removal step of removing an unsintered building material and the solvent from the building material layer such that a sintered building material is left on the working surface.

2. The method of manufacturing a three-dimensional object according to claim 1, wherein the building material layer forming step comprising:
ejecting an ink containing the building material and the solvent onto the working surface by an inkjet printing to form an ink layer; and
removing a part of the solvent from the ink layer formed on the working surface.

3. The method of manufacturing a three-dimensional object according to claim 1, wherein the building material layer forming step comprising:
disposing an ink containing the building material and the solvent onto the working surface in a layered manner by a screen printing.

4. The method of manufacturing a three-dimensional object according to claim 1, further comprising:
a depositing step of depositing a new building material layer on the building material layer which is formed on the working surface and in which the building material has been sintered,
wherein the sintering step comprising:
irradiating a building part of the new building material layer corresponding to a shape of the three-dimensional object with the laser light to sinter the building material.

5. The method of manufacturing a three-dimensional object according to claim 4, wherein the removal step comprising:
collectively removing the unsintered building materials and the solvents from a plurality of the building material layers which are deposited.

6. The method of manufacturing a three-dimensional object according to claim 2, further comprising:
a depositing step of depositing a new building material layer on the building material layer which is formed on the working surface and in which the building material has been sintered,
wherein the sintering step comprising:
irradiating a building part of the new building material layer corresponding to a shape of the three-dimensional object with the laser light to sinter the building material.

7. The method of manufacturing a three-dimensional object according to claim 6, wherein the removal step comprising:
collectively removing the unsintered building materials and the solvents from a plurality of the building material layers which are deposited.

8. The method of manufacturing a three-dimensional object according to claim 3, further comprising:
a depositing step of depositing a new building material layer on the building material layer which is formed on the working surface and in which the building material has been sintered,
wherein the sintering step comprising:
irradiating a building part of the new building material layer corresponding to a shape of the three-dimensional object with the laser light to sinter the building material.

9. The method of manufacturing a three-dimensional object according to claim 8, wherein the removal step comprising:
collectively removing the unsintered building materials and the solvents from a plurality of the building material layers which are deposited.

10. The method of manufacturing a three-dimensional object according to claim 1, wherein the building material layer forming step comprising:
ejecting an ink containing a coloring material, the building material and the solvent onto the working surface by an inkjet printing to form an ink layer; and
removing a part of the solvent from the ink layer formed on the working surface.

11. An ink for manufacturing a three-dimensional object, comprising:
a building material in a powdered form, which is a raw material for a three-dimensional object and is sintered when irradiated with a laser light;
a solvent for dispersing the building material; and
a binder for coupling particles of the building material in the solvent.

12. The ink for manufacturing a three-dimensional object according to claim 11, further comprising:
a coloring material, being dispersed in the solvent.
